(19) United States
(12) Patent Application Publication
(10) Pub. No.: US 2025/0103287 A1
(43) Pub. Date: Mar. 27, 2025

(54) DIRECT FIXED POINT TO FIXED POINT DATA CONVERSION APPROXIMATING FLOATING POINT PRECISION IN HARDWARE ACCELERATOR

(71) Applicant: Microsoft Technology Licensing, LLC, Redmond, WA (US)

(72) Inventors: Nir DAVID, Tel Aviv (IL); Oren ISTRIN, Tel Aviv (IL); Segev RAVGAD, Ramat Hasharon (IL); Anatoly TSVETOV, Kfar Yona (IL)

(21) Appl. No.: 18/474,943

(22) Filed: Sep. 26, 2023

(51) Int. Cl. G06F 7/485; G06F 7/487

(52) U.S. Cl. CPC G06F 7/485; G06F 7/4876

(57) ABSTRACT

Artificial intelligence (AI) operation is improved by combining pre-processing with quantization and post-processing with dequantization. Floating point conversion may be implemented as fixed point to fixed point conversion. Floating point conversion and precision may be mimicked, for example, using high precision parameters in a fixed point to fixed point conversion. Mimicking floating point using hardware acceleration reduces sequential operations, such as machine learning model preprocessing and quantization by a CPU, to one or two clock cycles in a single step operation. Accordingly, computing resources, such as computing device cameras, may provide raw data to a hardware accelerator configured to quickly render the input in the correct format to an inference model by simultaneously performing preprocessing and quantization, substantially reducing inference latency and device power consumption while freeing up a CPU for other tasks.

### BACKGROUND

A general-purpose processor, such as a central processing unit (CPU), may be implemented with customized hardware to perform hardware acceleration of one or more tasks. “Hardware acceleration” refers to the use of computer hardware designed to perform specific functions more efficiently than when compared to software running on a general-purpose processor. Hardware accelerator hardware may include, for example, a neural processing unit (NPU) and/or a graphics processing unit (GPU). An NPU is a specialized processing unit (e.g., a microprocessor) configured to accelerate performance of machine learning (ML) tasks for applications including neural networks. An NPU may be implemented to free up a CPU and/or GPU to perform other (e.g., non-ML) computing tasks. For example, an NPU may improve the performance of a convolutional neural network (CNN) that processes images (e.g., to detect/classify objects in images). In use, an NPU may receive input data in the form of tensors (multi-dimensional arrays of data), perform operations including convolutions on the input tensors, and generate a result (e.g., detected object classifications).

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems and methods disclosed herein combine pre-processing with quantization and post-processing with dequantization with respect to machine learning models. In one aspect, algorithms with float inputs are implemented as fixed point to fixed point (e.g., unsigned integer (uint) to integer (int)) algorithms. Accordingly, computing resources, such as computing device cameras, may provide raw data (e.g., uint RGB image data) to a hardware accelerator (e.g., neural processing unknit (NPU)) configured to quickly render the input in the correct format to an inference model by simultaneously performing preprocessing and quantization, substantially reducing inference latency and device power consumption while freeing up a CPU for other tasks.

In aspects, a computing system may include a hardware accelerator configured to receive data in a first fixed point format different from a second fixed point format that a ML model is configured to process. The hardware accelerator is further configured to convert the data from the first fixed point format to the second fixed point format in a first operation with a first set of parameters. The first operation approximates, but avoids, sequential operations comprising an intermediate conversion of the received data to a floating point format and conversion of the floating point format to the second fixed point format, which enables the data in the second fixed point format to approximate floating point precision. The hardware accelerator implements the ML model to process the data in the second fixed point format.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 shows a block diagram of system that provides improved AI operation by combining preprocessing and quantization or dequantization and post-processing in a fixed point to fixed point conversion that mimics intermediate floating point conversion, in accordance with an example embodiment.

FIG. 2 shows a block diagram of an example system for improved AI operation, in accordance with an example embodiment.

FIG. 3 shows a block diagram of an example system for combined pre-processing and quantization, in accordance with an example embodiment.

FIG. 4 shows a block diagram of an example system for combined dequantization and post-processing, in accordance with an embodiment.

FIG. 5A shows a flowchart of a process for improved AI operation by fixed point to fixed point conversion that mimics intermediate floating point conversion, according to an embodiment.

FIG. 5B shows a flowchart of a process for configuring an operation descriptor for use by a hardware accelerator for fixed point to fixed point conversion, according to an example embodiment.

FIG. 6 shows a block diagram of an example computer system in which embodiments may be implemented.

The subject matter of the present application will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

As set forth in the Background section, a general-purpose processor, such as a central processing unit (CPU), may be implemented with customized hardware to perform hardware acceleration of one or more tasks. Hardware accelerators may include, for example, a neural processing unit (NPU) and/or a graphics processing unit (GPU). An NPU is a specialized processing unit (e.g., a microprocessor) configured to accelerate performance of machine learning (ML) tasks for applications including neural networks. An NPU may be implemented to free up a CPU and/or GPU to perform other (e.g., non-ML) computing tasks. For example, an NPU may improve the performance of a convolutional neural network (CNN) that processes images (e.g., to detect/classify objects in images). In use, an NPU may receive input data in the form of tensors (multi-dimensional arrays of data), perform operations including convolutions on the input tensors, and generate a result (e.g., detected object classifications). CNNS may convolve data tensors (e.g., image data) with weight tensors. A large number of data tensors, which may be referred to as “channels,” and are each a fraction (image section) of an input image, are convolved with hundreds or thousands of “weights” of the weight tensors. The weights are filters, and by convolving them with the tensors, a desired result is achieved, such as a statistical labeling of the object(s) in the given input image.

NPUs may be configured to work with fixed point data (e.g., 8-bit integer (int8) data), as opposed to floating point data. An ML model (e.g., a CNN) may be configured to process a specific type of data in a specific format. For example, a CNN may be configured to process image data in int8 fixed point format where, for example, each pixel in an image comprises three 8-bit values for red, green, and blue (RGB). A camera, however, may generate image data in unsigned integer (uint8) fixed point format (does not include negative values), which is different from int8 format, which is signed (includes negative and positive values). A training process for image data may convert uint data to small floating point values, e.g., between zero (0) and one (1), for example, to improve convergence. Inference data may be handled similar to training data. For example, inference data may be generated in uint8, converted to floating point values during pre-processing (e.g., consistent with training) and the floating point values may be converted to fixed point int8 format during quantization (e.g., consistent with training) using parameters learned during training. Following processing by an inference model, such as identifying objects in an image, data output by an inference model may be dequantized to floating point values and post-processed to int8 fixed point values. If quantization is deemed to be part of a model, the model input and output are floating point values. If quantization is deemed to not be part of a model, the model input and output are fixed point int8 values. Preprocessing is generally performed before a model, which means a CPU may incur substantial latency and power consumption converting a large set of data.

As such, methods, systems, and computer program products are provided for enabling artificial intelligence (AI) optimization for combining pre-processing with quantization and post-processing with dequantization. Algorithms with float inputs may be implemented as fixed point to fixed point (e.g., unsigned integer (uint) to integer (int)) algorithms. A float algorithm and associated floating point precision may be mimicked, for example, using high precision parameters in a fixed point to fixed point algorithm. Mimicking floating point using hardware acceleration may reduce sequential operations, such as machine learning (ML) model preprocessing and quantization by a central processing unit (CPU), to one or two clock cycles in a single step operation. Accordingly, computing resources, such as computing device cameras, may provide raw data (e.g., uint RGB image data) to a hardware accelerator (e.g., neural processing unknit (NPU)) configured to quickly render the input in the correct format to an inference model by simultaneously performing preprocessing and quantization, substantially reducing inference latency and device power consumption while freeing up a CPU for other tasks.

For example, a computing system may include a hardware accelerator configured to receive data in a first fixed point format different from a second fixed point format that a ML model is configured to process; convert the data from the first fixed point format to the second fixed point format in a first operation with a first set of parameters, wherein the first operation approximates (e.g., mimics, simulates), but avoids, sequential operations comprising an intermediate conversion of the received data to a floating point format and conversion of the floating point format to the second fixed point format, which enables the data in the second fixed point format to approximate floating point precision; and implement the ML model to process the data in the second fixed point format.

Embodiments have numerous advantages. For instance, by converting data directly from a first fixed point format to a second fixed point format, the intermediate conversion to floating point data is avoided, which enables faster inference (lower latency) by a machine learning model executed by a hardware accelerator, lower energy consumption by the hardware accelerator, and the avoidance of additional hardware used to handle the conversion through floating point (i.e., existing hardware accelerator hardware may be utilized to perform the direct conversion). By replacing sequential CPU operations with a single hardware operation (e.g., involving multiplication and addition) in one or two clock cycles, inference latency and device power consumption may be substantially reduced while freeing up a CPU for other tasks. Furthermore, the mimicking of intermediate floating point conversion and floating point precision without the actual conversion through floating point maintains the benefits of the mimicked, but skipped, operations.

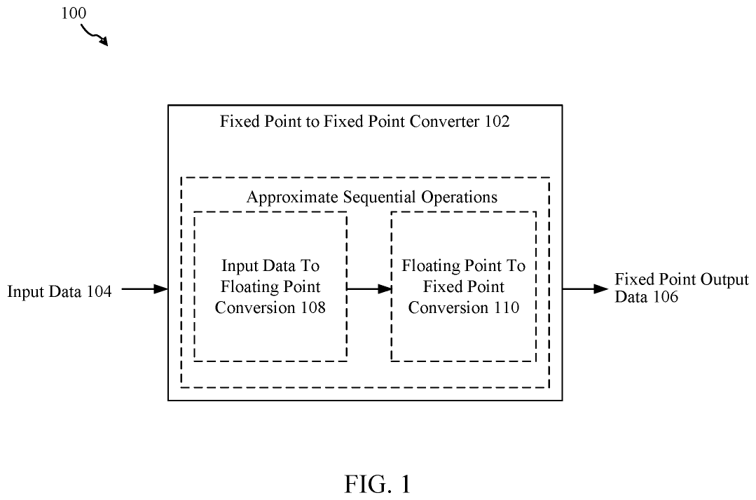

These and further embodiments may be configured in various ways. For instance, FIG. 1 shows a block diagram of a system 100 configured to combine pre-processing and quantization or dequantization and post-processing in a fixed point to fixed point conversion that mimics intermediate floating point conversion, in accordance with an example embodiment. As shown in FIG. 1, system 100 includes a fixed point to fixed point converter 102. Converter 102 enables sequential floating point conversion operations to be simulated by a direct fixed point to fixed point conversion, which may be implemented by a hardware accelerator, such as an NPU or GPU. The series or sequential floating point conversion operations of converter 102 simulated in the single operation may include, for example, inference input data preprocessing and quantization and/or output data dequantization and post-processing. As shown by example, an input data 104 received by converter 102 is the original, unprocessed representation of the input data. Input data 104 may have various formats, including being formatted according to an unsigned integer (uint) format, such as 8-bit uint (uint8), in the case of input data 104 being RGB (red-green-blue) image data. A fixed point output data 106 generated by converter 102 may be integer (int) format, such as 8-bit int (int8). Fixed point output data 106 may be processed further by the hardware accelerator, for example, implementing an inference model to generate inference data.

Fixed point to fixed point (e.g., uint to int or int to uint) conversion by converter 102 may be implemented to simulate skipped intermediate, conventional, floating point conversion operations. For instance, as shown in FIG. 1, converter 102 may be configured to approximate sequential operations, including one or both of an input data format to floating point conversion 108 and a floating point to fixed point conversion 110, so that rather than performing such conventional conversions 108 and 110, converter 102 performs a single fixed point to fixed point conversion that generates fixed point output data 106, which approximates (is identical to or nearly identical to, within an acceptable degree of precision (tolerance) for the particular application) the output result that would be attained if the conventional floating point conversions 108 and 110 actually were implemented. For example, high precision in a uint/int conversion may be maintained by utilizing high bit variables inside the conversion operation. For example a multiplier parameter may be 32 bits, supporting almost identical precision to floating point multiplication.

A fixed point to fixed point conversion by converter 102 merges sequential steps by merging and/or simplifying operations. For example, a conventional preprocessing stage that includes conversion 108 may divide uint8 data by 255 to normalize the data to floating point values between zero (0) and one (1). A conventional quantization stage, in conversion 110, may apply to the preprocessed floating point data a scale value M and a constant value K learned during model training. The fixed point to fixed point conversion of converter 102 simplifies and merges these conventional sequential stages, for example, by multiplying the uint8 data by a single multiplication factor (e.g., 1/(255*scale)) summed with the constant K. The fixed point to fixed point operation may be indicated to a hardware accelerator in an operation (op) descriptor. The operation may be a modified quantization operation simulating the sequential floating point conversion operations.

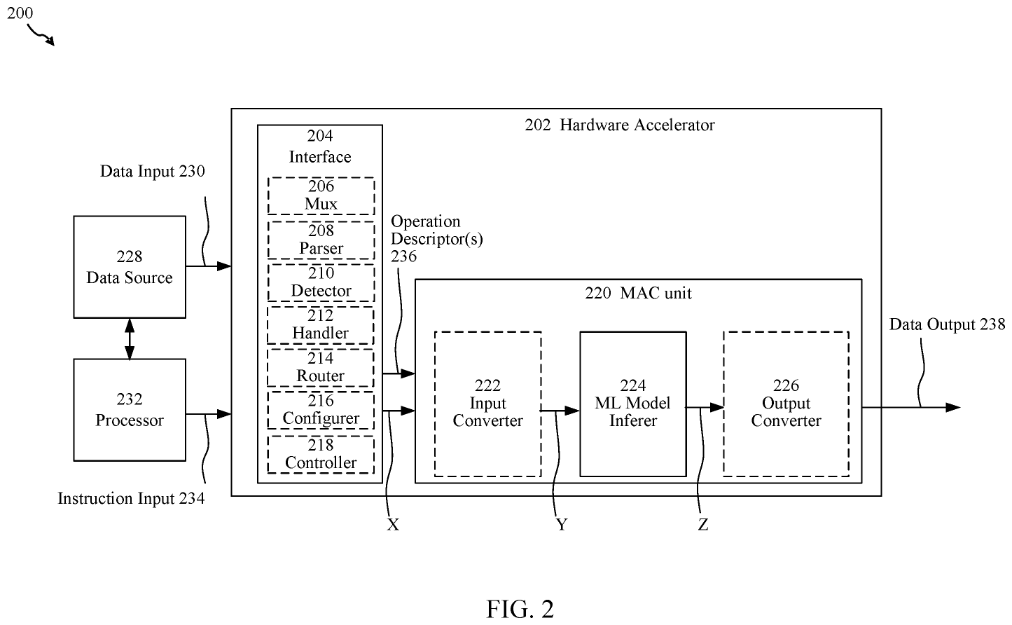

The fixed point to fixed point conversion of converter 102 in FIG. 1 may be implemented in various ways, in embodiments. For instance, FIG. 2 shows a block diagram of an example computing system 200 configured for improved AI operation, in accordance with an example embodiment. As shown in FIG. 2, computing system 200 may include, for example, a processor 232 (e.g., central processing unit (CPU)), a hardware accelerator 202 (e.g., NPU or GPU), and a data source 228 (e.g., camera, memory). Hardware accelerator 202 includes an interface 204 and a multiply-accumulate (MAC) unit (e.g., a systolic array). Interface 204 includes a multiplexer (mux) 206, a command parser 208, a detector 210, an input handler 212, a data router 214, a configurer 216, and a controller 218. MAC unit 220 may be configured to operate, for example, as an input converter 222, an ML model inferer 224, and/or an output converter 226, e.g., among other functions. Note that not all of these components need be present in all embodiments. In some examples, there may be more or fewer components, including different components. In some examples, computing system 200 may be implemented as a system on a chip (SoC) or in other manners. These components of example computing system 200 are described in further detail as follows.

Processor 232 may comprise any type of processor, microcontroller, a microprocessor, signal processor (e.g., digital signal processor (DSP)), application specific integrated circuit (ASIC), and/or other physical hardware processor circuit) for performing computing tasks, such as program execution, signal coding, data processing, input/output processing, power control, and/or other functions. Processor 232 is configured to execute program code, such as an operating system and/or application programs (e.g., machine learning (ML), artificial intelligence (AI)), which may invoke use of one or more hardware accelerators, such as NPUs or GPUs (e.g., as described herein), for example, to process images. Processor 232 may perform operations, e.g., based on execution of executable code, which may include one or more steps in processes/methods disclosed herein.

Processor 232 may provide instruction input 234 and/or data input 230 to hardware accelerator 202. Processor 232 may issue one or more commands directed to one or more components in hardware accelerator 202, as indicated by instruction input 234. CPU may initiate a transaction with data source 228, such as a camera or memory. For example, processor 232 may read one or more tensor packages from data source 228, e.g., for processing by hardware accelerator 202 implementing an inference model. Processor 232 may indicate to hardware accelerator 202 one or more operations to be performed on data input 230 provided by data source 228. For example, processor 232 may indicate to hardware accelerator 202 via instruction input 234 that tensor packages read from data source 228 should be prepared for model processing by performing a fixed point to fixed point conversion, e.g., while simulating but not performing intermediate floating point conversion.

Data source 228 may provide data input 230 to hardware accelerator 202 and/or to processor 232. Data source 228 may include any type of data source, e.g., data generating or data storage resource. For example, data source 228 may include a camera or memory resource in a computing device. Data source 228 may include any type of storage technology, e.g., static random access memory (SRAM), synchronous dynamic random access memory (SDRAM), etc. Data source 228 may store any type of information, e.g., data, weights, for operations performed by processor 232 and/or hardware accelerator 202. Data source 228 may generate and/or store any number of tensor packages. For example, data source 228 may include a camera that generates raw image data, e.g., in the form of unsigned integer (uint) RGB data.

Hardware accelerator (e.g., NPU) 202 may be a specialized processing unit (e.g., a microprocessor) configured to accelerate performance of machine learning (ML) tasks, e.g., for neural network applications. An NPU hardware accelerator 202 may be implemented to free up processor 232 and/or a graphical processing unit (GPU) (not shown) to perform other (e.g., non-ML) computing tasks. For example, hardware accelerator 202 may improve the performance of a CNN that processes images. Hardware accelerator 202 may receive data input 230 in the form of tensors, perform operations including convolutions on the input tensors (e.g., based on instruction input 234 from processor 232), and generate a result. Data in a tensor may be organized in a multi-dimensional array of vectors.

Hardware accelerator 202 may be configured to perform data conversions, for example, to render data compatible with one or more algorithms or models implemented by hardware accelerator 202. Hardware accelerator 202 may be configured to receive (e.g., via interface 204) raw data from a data source 228, such as a camera associated with a computing device. The raw data may not be in a format suitable for processing by an algorithm or model implemented by hardware accelerator 202. Hardware accelerator 202 may be configured, (e.g., by instruction input 234), for example, to accelerate or optimize conversion operations. For example, hardware accelerator 202 may be configured to combine pre-processing and quantization and/or dequantization and post-processing by performing a fixed point to fixed point conversion that mimics intermediate floating point conversion (e.g., to mimic floating point precision), for example, to maintain or improve algorithm or model inference performance for processed data.

Interface 204 of hardware accelerator 202 may receive data input 230 (e.g., tensor packages) from data source 228 and instruction input 234 from processor 232. Data input may include one or more tensors. Instruction input 234 may include one or more tensor descriptors. Tensor descriptors may identify one or more operations for hardware accelerator 202 to perform on tensors. Tensor descriptors may (e.g., additionally and/or alternatively) identify one or more parameters for the one or more operations. For example, parameters may include multiplication and/or addition values used in a data format conversion operation.

Multiplexer (Mux) 206 may provide data information (e.g., tensor packages) to input handler 212 and control information (e.g., commands, tensor descriptors) to command parser 208. Multiplexer may be controlled, for example, by controller 218, command parser 208, and/or input handler 212.

Command parser 208 may parse commands generated by processor 232. Command parser 208 may decode commands and distribute parsed commands to one or various components, such as input handler 212 and/or controller 218. Parsed commands provided to input handler 212 and/or controller 218 may include, for example, MAC unit or systolic array (e.g., matrix) size, tensor package size, tensor package format, data validity indicator, operation description (e.g., conversion(s), concatenation(s), convolution(s), iteration(s)), etc.

Detector 210 may detect the type and/or format of data input 230. Detector 210 may provide an indication of the type and/or format of data input 230 to configurer 216 and/or controller 218. For example, detector 210 may detect that the type of data input 230 is an image and/or that the format of data input 230 is 8-bit or 16-bit unsigned integer or floating point data. Indications distinguishing the type and/or format of data may be used to configure and/or to make determinations in handler 212, data router 214, configurer 216, controller 218, and/or MAC unit 220.

Input handler 212 may receive data input 230 (e.g., tensor data) from data source 228 via mux 206. Input handler 212 may receive instructions for handling tensor data from command parser 208. Input handler 212 may execute a hardware-implemented algorithm that operates according to the operation/tensor descriptor(s) associated with the tensors parsed by command parser 208. Input handler 212 may generate an indication (e.g., a set of commands or parameters) for data router 214. For example, input handler 212 may associate a routing indication with each tensor package consistent with one or more operations (e.g., conversion(s), concatenation(s), convolution(s), iteration(s)) indicated in one or more operation/tensor descriptors provided by processor 232 in instruction input 234.

Data router 214 may receive tensor packages and one or more indications of how to route the tensor packages to accomplish the operation(s) (e.g., conversion(s), concatenation(s), convolution(s), iteration(s)). Data router 214 may perform a hardware-implemented algorithm according to the data and routing indication(s) received from input handler 212. Data router 214 may route tensor data according to routing indications from input handler 212 consistent with an operation (e.g., conversion(s), concatenation(s), convolution(s), iteration(s)) commanded by processor 232. For some operations (e.g., conversion operations and/or convolution operations), data router 214 may (e.g., also) route other information, such as information determined by configurer 216, weights, etc., based on routing of tensor packages to data memories in MAC unit 220. As shown by example, with reference to one or more equations in examples described herein, routed input data (e.g., routed to MAC unit 220 for a conversion operation) is identified as “X.”

Configurer 216 may configure MAC unit 220 for the operation(s) and/or parameter(s) that may be determined and/or indicated based on operation descriptor(s) 236. Configurer 216 may perform a hardware-implemented algorithm. Configurer 216 may receive one or more indications from detector 210 that indicate the type(s) of data and/or format(s) of data in data input 230. Configurer 216 may receive one or more indications from controller 218 that indicate the one or more operations to be performed on the routed data X (e.g., routed raw input data). Configurer 216 may determine a configuration of MAC unit 220 for routed data input X, for example, based on received information and/or based on the determination logic implemented by configurer 216. For example, configurer 216 may select parameters from a look up table (LUT) for the input type, input format, input size, input routing, MAC unit size, indicated operation(s), etc.

Controller 218 may control (re)configuration, input, storage, and output for MAC unit 220, for example, by controlling data valid signals to data memories in MAC unit 220 based on determinations when data router 214 is configured and ready for tensor data passed through input handler 212 to be read/written into data memories. For example, controller 218 may (re)configure MAC unit 220 for one or more operations to a specified N×M matrix of processing elements (PEs) with specified sizes of PE data memories, weight memories, and/or other parameters, such as conversion multiplication values, summation values, etc. Controller 218 may receive parsed commands from command parser 208, for example, to control MAC unit 220 data valid, write enable, and/or other signals consistent with the operation(s) being implemented by MAC unit 220 based on operation descriptor(s) 236. In some examples, controller 218 may generate operation descriptor(s) 236 based on instruction input 234.

MAC unit (e.g., systolic array) 220 may comprise a (e.g., dynamically reconfigurable) N×M array (e.g., matrix) of processing elements (PEs). MAC unit 220 may be variable (e.g., a selectable sized array or matrix), for example, to support scalability (e.g., handling a wider variety of ML tasks). PEs may be referred to as cells or clusters. Each PE may include, for example, a PE data memory, a weight memory, processing logic, and a control interface. MAC unit 220 may be configured for operations, for example, by configurer 216 and/or controller 218. Data router 214 may route input data 230 to the configured MAC unit 220 for the operation(s).

As shown in MAC unit 220, controller 218 may configure MAC unit 220 as an input converter 222. Data router 214 may route data input 230 to MAC unit 220 as routed input data X. Routed input data X may be fixed point input, such as unsigned integer (uint) format (e.g., 8-bit uint (uint8)). The operation indicated in operation descriptor(s) 236 may indicate a fixed point to fixed point conversion simulating intermediate floating point conversion using high precision parameters (e.g., 32-bit multiplication operation). Note that the use of operation descriptors 236 to convey the fixed point to fixed point conversion enables the conversion to be performed using existing functionality and capabilities of MAC 220 without modification to the hardware of MAC 220.

Conversion output data Y generated by input converter 222 in MAC unit 220 may be 8-bit integer (int8). In various implementations, detector 210 may detect the type of data, format of data, size of data, etc., which configurer 216 may use to configure input converter 222 in MAC unit 220 for the indicated conversion operation(s).

Input converter 222 may generate fixed point output in accordance with the specified operation. As shown in FIG. 2, the fixed point may be integer (int) format, such as 8-bit int (int8).

Fixed point to fixed point (e.g., uint to int or int to uint) conversion may be implemented to simulate skipped intermediate floating point conversion operations so that the converted output is identical or nearly identical to the output if the floating point conversions were implemented. For example, high precision in a uint/int conversion may be maintained by utilizing high bit variables inside the conversion operation. For example a multiplier parameter may be 32 bits, supporting almost identical precision to floating point multiplication.

Input converter 222 may be configured, e.g., by configurer 216, to merge sequential steps by merging and/or simplifying operations. For example, a preprocessing stage may divide routed input data X (e.g., uint8 data) by 255 to normalize the data to floating point values between zero (0) and one (1). A quantization stage may apply to the preprocessed floating point data a scale value M and a constant value K learned during training of ML model inferer 224. Configurer 216 may simplify and merge the sequential stages, for example, by configuring input converter 222 to multiply the routed input data X (e.g., uint8 data) by a single multiplication factor (e.g., 1/(255*scale)) summed with the constant K, which may occur, for example, in two clock cycles of MAC unit 220. The operation may be a modified quantization operation simulating the skipped intermediate sequential floating point conversion operations.

The converted output (e.g., fixed point output) data Y may be processed further by hardware accelerator 202, for example, since the data input 230 was converted to a format compatible with the ML inference model, e.g., conversion output data Y. Controller 218 may configure MAC unit 220 as ML model inferer 224 to process converted output data Y. In an example, the ML inference model may infer objects in image data. For example, controller 218 may configure hardware accelerator (e.g., NPU) to implement an inference model to generate inference data for imagery in data input 230, which has been processed to converted data Y. ML model inferer 224 may classify objects in a still or video image captured by a camera data source 228. ML model inferer 224 may generate output Z, for example, in the same format as input data (e.g., fixed point data in int8 format).

As shown in MAC unit 220, controller 218 may configure MAC unit 220 as an output converter 226, for example, to convert the output of ML model inferer 224 (e.g., model output Z) to a different format. The operation indicated in operation descriptor(s) 236 may indicate the output format following one or more operations (e.g., conversion of input from uint8 to int8, model processing, conversion of model output from int8 to uint8). Output converter 226 may be configured to perform a fixed point to fixed point conversion simulating intermediate floating point conversion using high precision parameters (e.g., 32-bit multiplication operation). Model output data Z generated by ML model inferer 224 in MAC unit 220 may be 8-bit integer (int8). Configurer 216 may configure output converter 226 in MAC unit 220 for the indicated conversion operation(s).

Output converter 226 may generate fixed point output in accordance with the specified operation. As shown in FIG. 2, model output Z may be integer (int) format, such as 8-bit int (int8).

Fixed point to fixed point (e.g., int to uint) conversion may be implemented to simulate skipped intermediate floating point conversion operations so that the converted output is identical or nearly identical to the output if the floating point conversions were implemented. For example, high precision in an int/uint conversion may be maintained by utilizing high bit variables inside the conversion operation. For example a multiplier parameter may be 32 bits, supporting almost identical precision to floating point multiplication.

Output converter 226 may be configured, e.g., by configurer 216, to merge sequential steps by merging and/or simplifying operations. For example, a dequantization stage may apply to the preprocessed floating point data a constant value −K and a scale value 1/M learned during training of ML model inferer 224. A postprocessing stage may multiply model output data Z (e.g., int8 data) by 255 to normalize the data to floating point values between zero (0) and one (1). Configurer 216 may simplify and merge the sequential stages, for example, by configuring output converter 226 to multiply model output data Z (e.g., int8 data) by a single multiplication factor (e.g., 255*scale) summed with the constant −K, which may occur, for example, in two clock cycles of MAC unit 220. The operation may be a modified dequantization operation simulating the skipped intermediate sequential floating point conversion operations.

Output converter 226 may generate data output 238, for example, in the same format as data input 230, although input and output data may have different formats in a wide variety of implementations. MAC unit 220 may be configured as input converter 222 and/or output converter 226 as needed, for example, based on input type and format detected by detector 210 and operation descriptor(s) 236. Data output 238 may be handled, for example, by an output handler (not shown). Data output 238 may represent computational results (e.g., computed tensors) generated by a compute layer. The computed tensors may be or may include partial sums (PSums). An output handler may perform operations on the received computed tensors (e.g., to generate output tensor package(s)), which may be output (e.g., returned as results to processor 232) via mux 206 or fed back to MAC unit 220 through input handler 212 (e.g., for further processing, such as iterative or additional operations).

Table 1 presents an example of code that may be executed by processor 232 to configure hardware accelerator 202 to perform a fixed point to fixed conversion of data input 230 while simulating intermediate floating point conversion.

```
TABLE 1
void ReferenceMathOpsConstMul:: run_const_mul(const
s_systolic_math_ops&
math_descriptor, const int8_t* p_input_data )
  const int16_t const_input = math_descriptor.input2_multiplier +
  math_descriptor.input2_offset ;
  const size_t flat_size = math_descriptor.tensor_depth *
  math_descriptor.tensor_height * math_descriptor.tensor_width;
  auto cluster_addr =
  get_cluster_address(math_descriptor.clustr_data_dst,
  math_descriptor.base_addr_output_clust_wr);
  for (auto i = 0lu; i < flat size ; ++i)
  {
    int32_t unclamped_output = (p_input_data[i] +
    math_descriptor.input1_offset) * const_input ;
    unclamped_ output = math_descriptor.output_offset +
    multiply_by_quant_multiplier(unclamped_output,
    math_descriptor.output
    _multiplier, restore_shift_value(math_descriptor.output_shift));
    const int32_t clamped_output =
    std::min<int32_t>(math_descriptor.quantized_activation_max,
    std::max<int32_t>(math_descriptor.quantized_activation_min,
    unclamped_output));
    m_cluster_mem[math_descriptor.clustr_data_dst][cluster_addr +
    i] =
    static_cast<int8_t>(clamped_output);
    }
  }
```

In Table 1 above, processor 232 may insert a hardware conversion operation with indicated parameters in instructions for hardware accelerator 202. The hardware conversion operation may be attached to an operation (op). An op (e.g., each op) may have one or more hardware operations, each with its own instructions. A conversion operation may precede and/or follow model inference operation(s). The math_descriptor may be adjusted, for example, by adjusting variables to match a desired multiplier M and constant. For example, an NPU quantization block (e.g., run_const_mul function) may be executed with a hardware operation to perform fixed point to fixed point conversion while simulating skipped floating point conversion, which mimics sequential preprocessing and quantization stages.

Quantization accuracy may be determined for mimicked floating point conversion. In an example, 8-bit RGB inputs with values up to 255, 32-bit math_op variables, and a max scale value of one (1), provide significant error margin for trained inference models with a minimum of 1e\hat{ }−3/−4. Quantization error may be zero (0) for scale 1e\hat{ }−6. Quantization error may be +/−1 for scale 1e\hat{ }−7. Quantization error may be +/−10 for scale 1e\hat{ }−8. A worst case may be, for example, (2\hat{ }32)/255/255, where the first 255 refers to a floating point normalization equivalent and the second 255 refers to a maximum input value, which indicates that 2\hat{ }32/2\hat{ }16=2\hat{ }16 would avoid overflow.

Advantages of single-step hardware data conversion from fixed point to fixed point while simulating or mimicking skipped intermediate floating point conversion may include, for example, faster inference (e.g., lower latency per operation), lower energy consumption, and zero cost implementation on existing hardware, utilizing multiplication and addition functionality with new op descriptors.

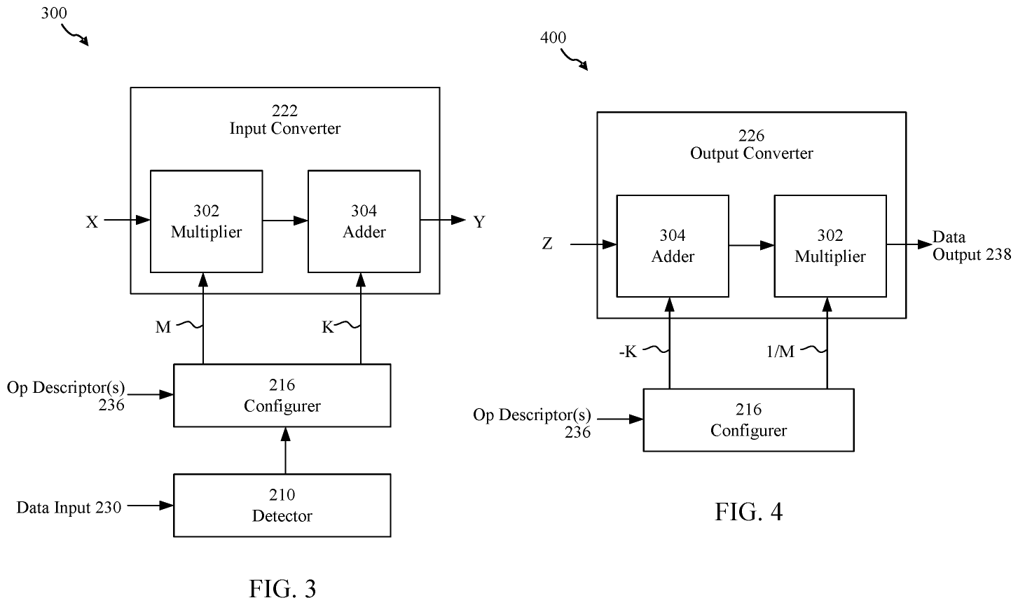

FIG. 3 shows a block diagram of an example of a computing system 300 for combined pre-processing and quantization, in accordance with an example embodiment. System 300 shows a further example of the example shown in FIGS. 1 and 2. As shown in FIG. 3, system 300 includes detector 210, configurer 216, and input converter 222 (e.g., in MAC unit 220) of FIG. 2. Furthermore, input converter 222 may comprise a multiplier 302 and an adder 304, which may represent an array of MAC units or PEs in MAC unit (e.g., systolic array) 220. These features of FIG. 3 are described in further detail as follows.

Detector 210 may be configured to perform an automated detection of data input 230, for example, to support dynamic adaptation of input converter 222 and/or output converter 226. Detector 210 may detect the type and/or format of data input 230. Detector 210 may provide an indication of the type and/or format of data input 230 to configurer 216 and/or controller 218. For example, detector 210 may detect that the type of data input 230 is an image and/or that the format of data input 230 is 8-bit or 16-bit unsigned integer or floating point data. Indications distinguishing the type and/or format of data may be used to configure and/or to make determinations in input handler 212, data router 214, configurer 216, controller 218, and/or MAC unit 220.

Configurer 216 may configure MAC unit 220 for one or more operations and/or parameter(s) that may be determined and/or indicated based on operation descriptor(s) 236. For example, configurer 216 may receive an indication of the type and/or format of data input 230 from detector 210. Configurer 216 may determine whether and if so how MAC unit 220 should be configured to convert data input 230 for compatibility with a model implemented by MAC unit 220. Configurer 216 may perform a hardware-implemented algorithm. Configurer 216 may receive one or more indications from detector 210 that indicate the type(s) of data and/or format(s) of data in data input 230. Configurer 216 may receive one or more indications from controller 218 that indicate the one or more operations to be performed on the routed data X (e.g., routed raw input data). Configurer 216 may determine a configuration of MAC unit 220 for routed data input X, for example, based on received information and/or based on the determination logic implemented by configurer 216. For example, configurer 216 may select parameters from a look up table (LUT) for the input type, input format, input size, input routing, MAC unit size, indicated operation(s), etc.

As shown in FIG. 3, configurer 216 may be indicated by detector 210 and/or op descriptor(s) 236 to configure input converter 222 to perform a fixed point to fixed point conversion of routed input X while simulating intermediate floating point conversion. Configurer 216 may configure input converter 222 with conversion parameters including multiplier M and constant K, which may be determined as follows. Assuming detector indicates the format of data input 230 is uint8, a preprocessing stage may divide data input 230 by 255 to normalize input data 230 to floating point values between zero (0) and one (1), for example, in accordance with Eq. (1):

$$Intermed . floating point vaue = input data / 255 \qquad ( 1 )$$

A quantization stage may apply to the preprocessed intermediate floating point values a scale value and a constant value zero point (ZP) value learned during training of ML model inferer 224, for example, in accordance with Eq. (2):

$$Quantized value = Intermed . floating point value / scale + ZP \qquad ( 2 )$$

The sequential stages or operations indicated by Eq. (1) and Eq. (2) may be merged into a single operation, for example, as shown in Eq. (3):

$$Converted value = Input value / scale / 255 + Z P \qquad ( 3 )$$

Eq. (3) may be simplified, for example, as shown in Eq. (4):

$$Y = X * M + K \qquad ( 4 )$$

With reference to Eq. (4), Y is the converted data, X is the conversion input data, K is the constant ZP, and M is a multiplier equal to 1/(255*scale). With reference to the code example in Table 1, Y may be unclamped_output, K may be math_descriptor.output_offset, X may be P_input_data[i], and M may be math_descriptor.output_multiplier*2\hat{ }(math_descriptor.output_shift−31).

As shown by Eq. (4), configurer 216 may configure input converter 222 to multiply routed input data X (e.g., uint8 data) by a single multiplication factor M and sum the product with the constant K in two clock cycles of hardware accelerator 202. The equations and/or parameters referenced in Eq. (1)-Eq. (4) may vary among implementations based on, for example, the expected format for the algorithm or model implemented by hardware accelerator 202, the detected input type(s) and/or format(s), etc.

Input converter 222 may implement the fixed point to fixed point conversion using configured multiplier 302 and adder 304. Multiplier may multiply X by M and adder 304 may add K to the product, resulting in converted output Y in accordance with Eq. (4). In some examples, routed input X may be uint8 format while converted output Y may be int8 format. The conversion operation implemented by input converter 222 may be a modified quantization operation simulating the skipped intermediate sequential floating point conversion operations, and thereby enabling faster inference/lower latency, lower energy consumption, and the use of existing hardware of MAC unit 220. The fixed point to fixed point conversion by input converter 222 may be implemented to simulate skipped intermediate floating point conversion operations so that the converted output Y is identical or nearly identical to the output if the intermediate floating point conversions were implemented. Multiplier 302 may be implemented, for example, with 32 bits, supporting almost identical precision to floating point multiplication. Accordingly, fewer parameters (e.g., M and K) are used by input converter 222 (and analogously, by output converter 226, as further described below) to implement the direct fixed point to fixed point conversion, relative to the conversion through floating point, which has the benefits of faster inference (via the single operation of Eq. (4)) and commensurate lower latency, lower energy consumption, and the ability to use existing hardware.

FIG. 4 shows a block diagram of a computing system 400 for combined dequantization and post-processing, in accordance with an embodiment. System 400 is a further example of the example shown in FIGS. 1 and 2. As shown in FIG. 4, system 400 includes configurer 216 and input converter 222 (e.g., in MAC unit 220) of FIG. 2. Output converter 226 may (e.g., like input converter 222 of FIG. 3) comprise a multiplier 302 and an adder 304, which may represent an array of MAC units or PEs in MAC unit (e.g., systolic array) 220. These features of FIG. 4 are described in further detail as follows.

Configurer 216 may configure MAC unit 220 for one or more operations and/or parameter(s) that may be determined and/or indicated based on operation descriptor(s) 236. For example, configurer 216 may determine whether and if so how MAC unit 220 should be configured to convert model data output Z to provide the desired format of data output 238. The format of model output Z may be known or indicated. Configurer 216 may perform a hardware-implemented algorithm. Configurer 216 may receive one or more indications from controller 218 (e.g., op descriptor(s) 236 that indicate the one or more operations to be performed on the routed data X (e.g., routed raw input data). Configurer 216 may determine a configuration of MAC unit 220 for output data Z, for example, based on received information, known information, and/or based on the determination logic implemented by configurer 216. For example, configurer 216 may select parameters from a look up table (LUT) for the model output type, model output format, data output format, etc.

As shown in FIG. 4, configurer 216 may be indicated by op descriptor(s) 236 to configure output converter 226 to perform a fixed point to fixed point conversion of model output Z while simulating intermediate floating point conversion. Configurer 216 may configure output converter 226 with conversion parameters, including multiplier 1/M and constant −K, which may be determined as follows. Assuming detector indicates the format of model output Z is int8 and data output 238 is uint8, a dequantization stage may apply to model output Z (e.g., quantized output with fixed point values in int8 format) the scale value and constant ZP learned during training of ML model inferer 224, as shown in FIG. (5):

$$Intermed . floating point value = ( quantized model output Z - ZP ) * scale \qquad ( 5 )$$

A postprocessing stage may multiply the intermediate floating point value by 255 to convert the intermediate floating point values between zero (0) and one (1) back to uint8 values, for example, in accordance with Eq. (6):

$$Data output = Intermed . floating point value * 255 \qquad ( 6 )$$

The sequential stages or operations indicated by Eq. (5) and Eq. (6) may be merged into a single operation, for example, as shown in Eq. (7):

$$Converted value = ( quantized model output Z - ZP ) * scale * 255 \qquad ( 7 )$$

Eq. (7) may be simplified, for example, as shown in Eq. (8):

$$Data Output = ( Z - K ) * 1 / M \qquad ( 8 )$$

With reference to Eq. (8), Z is the model output data, K is the constant ZP, and M is a multiplier equal to 1/(255*scale).

As shown by Eq. (8), configurer 216 may configure output converter 226 to subtract constant K from model output data Z (e.g., int8 data) and multiply the result by a single multiplication factor 1/M in two clock cycles of hardware accelerator 202. The equations and/or parameters referenced in Eq. (5)-Eq. (8) may vary among implementations based on, for example, the output data format for the algorithm or model implemented by hardware accelerator 202, the expected output format(s), etc.

Output converter 226 may implement the fixed point to fixed point conversion using configured multiplier 302 and adder 304. Adder 302 may add a negative value of K to Z and multiplier 302 may multiply the result by 1/M, resulting in data output 238 in accordance with Eq. (8). In some examples, model output Y may be int8 format while data output 238 may be uint8 format. The conversion operation implemented by output converter 226 may be a modified dequantization operation simulating the skipped intermediate sequential floating point conversion operations. The avoidance of the intermediate sequential floating point conversion operations by the modified dequantization operation has benefits, including enabling the faster providing of inference results/lower latency, lower energy consumption, and the ability to use existing hardware of MAC unit 220. The fixed point to fixed point conversion by output converter 226 may be implemented to simulate skipped intermediate floating point conversion operations so that the data output 238 is identical or nearly identical to the output if the intermediate floating point conversions were implemented. Multiplier 302 may be implemented, for example, with 32 bits, supporting almost identical precision to floating point multiplication.

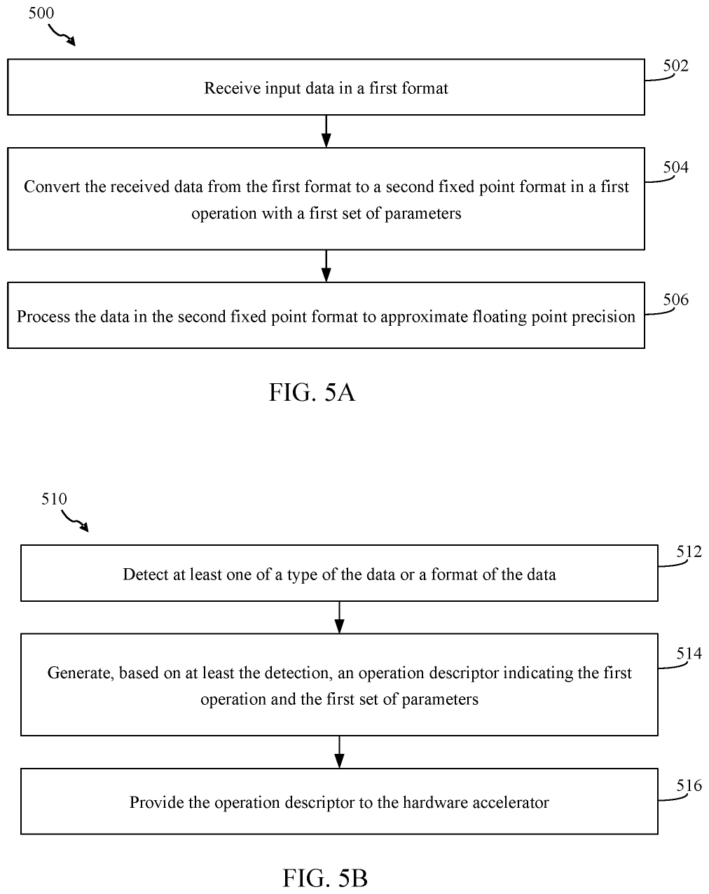

Embodiments described herein may operate in various ways. For instance, FIG. 5A shows a flowchart 500 of a process for improved AI operation by fixed point to fixed point conversion that mimics intermediate floating point conversion, according to an embodiment. Example computing systems 100, 200, 300, and 400, as shown by examples in FIGS. 1-4, may operate according to flowchart 500, e.g., in some embodiments. For example, example flowchart 500 may be implemented by detector 210, configurer 216, input converter 222, and/or output converter 226. Various embodiments may implement one or more steps shown in FIG. 5A with additional and/or alternative steps. Further structural and operational embodiments will be apparent to persons skilled in the relevant art(s) based on the following description of FIG. 5A.

Flowchart 500 includes step 502. In step 502, input data in a first format is received. For example, as shown in FIG. 2, hardware accelerator 202 receives data input 230 from data source 228. As shown by example, data input 230 may be in uint8 format.

In step 504, the received data may be converted from the first fixed point format to a second fixed point format in a first operation with a first set of parameters. The first operation mimics sequential operations comprising an intermediate conversion of the first fixed point format to a floating point format and conversion of the floating point format to the second fixed point format. For example, as shown in FIGS. 1-4, input converter 222 may convert routed input X (e.g., in uint8 format) to converted data Y (e.g., in int8 format) and/or output converter 226 may convert model output Z (e.g., in int8 format) to data output 238 (e.g., in uint8 format), while simulating intermediate floating point conversion using high precision operations (e.g., 32-bit multiplication).

In step 506, the data in the second fixed point format may be processed to approximate floating point precision. For example, as shown in FIG. 2, ML model inferer 224 may use converted output Y, which mimic floating point precision.

In an embodiment, as described above, one or more operations and/or parameters utilized during the fixed point to fixed point conversion may be determined based on one or more operation descriptors. For instance, FIG. 5B shows a flowchart 510 of a process for configuring an operation descriptor for use by a hardware accelerator for fixed point to fixed point conversion, according to an example embodiment. Flowchart 500 may be implemented by hardware accelerator 202, for example. Further structural and operational embodiments will be apparent to persons skilled in the relevant art(s) based on the following description of FIG. 5B.

Flowchart 510 includes step 512. In step 512, at least one of a type of the data or a format of the data is detected. For instance, as further described elsewhere herein, detector 210 may detect the type and/or format of data input 230. Detector 210 may provide an indication of the type and/or format of data input 230 to configurer 216 and/or controller 218. For example, detector 210 may detect that the type of data input 230 is an image and/or that the format of data input 230 is 8-bit or 16-bit unsigned integer or floating point data.

In step 514, an operation descriptor indicating the first operation and the first set of parameters is generated based at least on the detection. For example, as further described elsewhere herein, controller 218 may generate an operation descriptor 236 based on the data type(s) and/or data format(s) detected by detector 210.

In step 516, the operation descriptor is provided to the hardware accelerator. For instance, as further described elsewhere herein, configurer 216 may receive the operator descriptor 236 generated by controller 218. Configurer 216 may configure MAC unit 220 for the operation(s) and/or parameter(s) that may be determined and/or indicated based on operation descriptor(s) 236. Data router 214 may route input data 230 to the configured MAC unit 220 for the operation(s). As described elsewhere herein, an operation indicated in operation descriptor 236 may indicate a fixed point to fixed point conversion by MAC unit 220 simulating intermediate floating point conversion using high precision parameters.

### III. Example Computing Device Embodiments

As noted herein, the embodiments described, along with any circuits, components and/or subcomponents thereof, as well as the flowcharts/flow diagrams described herein, including portions thereof, and/or other embodiments, may be implemented in hardware, or hardware with any combination of software and/or firmware, including being implemented as computer program code (program instructions) configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

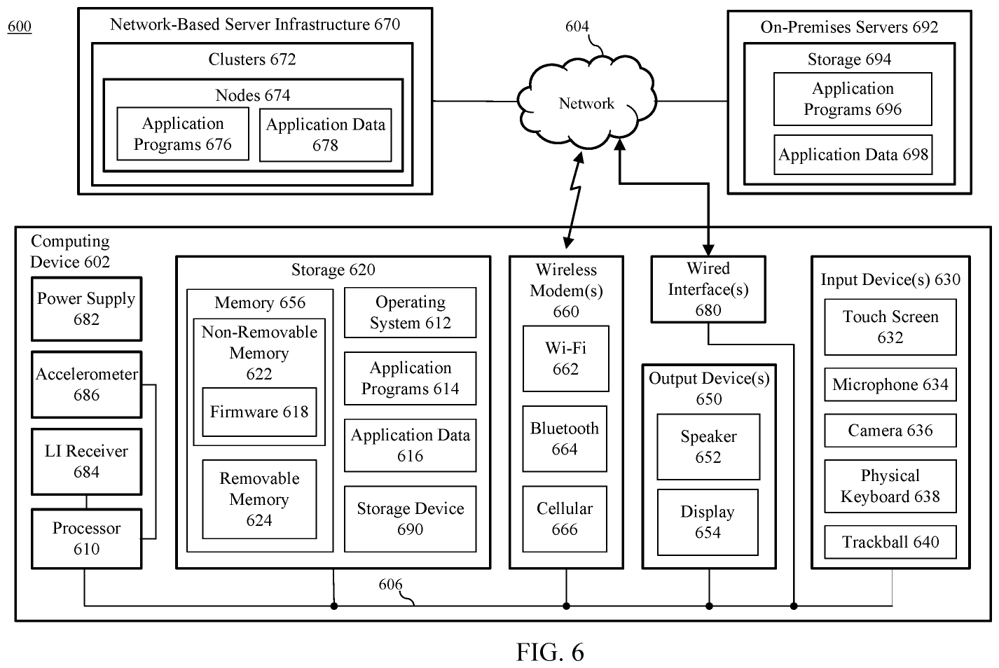

Embodiments disclosed herein may be implemented in one or more computing devices that may be mobile (a mobile device) and/or stationary (a stationary device) and may include any combination of the features of such mobile and stationary computing devices. Examples of computing devices in which embodiments may be implemented are described as follows with respect to FIG. 6. FIG. 6 shows a block diagram of an exemplary computing environment 600 that includes a computing device 602. Computing device 602 is an example of computing system 200 with hardware accelerator 202 shown in FIG. 2, which may include one or more of the components of computing device 602. In some embodiments, computing device 602 is communicatively coupled with devices (not shown in FIG. 6) external to computing environment 600 via network 604. Network 604 comprises one or more networks such as local area networks (LANs), wide area networks (WANs), enterprise networks, the Internet, etc., and may include one or more wired and/or wireless portions. Network 604 may additionally or alternatively include a cellular network for cellular communications. Computing device 602 is described in detail as follows.

Computing device 602 can be any of a variety of types of computing devices. For example, computing device 602 may be a mobile computing device such as a handheld computer (e.g., a personal digital assistant (PDA)), a laptop computer, a tablet computer (such as an Apple iPad™), a hybrid device, a notebook computer (e.g., a Google Chromebook™ by Google LLC), a netbook, a mobile phone (e.g., a cell phone, a smart phone such as an Apple® iPhone® by Apple Inc., a phone implementing the Google® Android™ operating system, etc.), a wearable computing device (e.g., a head-mounted augmented reality and/or virtual reality device including smart glasses such as Google® Glass™, Oculus Rift® of Facebook Technologies, LLC, etc.), or other type of mobile computing device. Computing device 602 may alternatively be a stationary computing device such as a desktop computer, a personal computer (PC), a stationary server device, a minicomputer, a mainframe, a supercomputer, etc.

As shown in FIG. 6, computing device 602 includes a variety of hardware and software components, including a processor 610, a storage 620, one or more input devices 630, one or more output devices 650, one or more wireless modems 660, one or more wired interfaces 680, a power supply 682, a location information (LI) receiver 684, and an accelerometer 686. Storage 620 includes memory 656, which includes non-removable memory 622 and removable memory 624, and a storage device 690. Storage 620 also stores an operating system 612, application programs 614, and application data 616. Wireless modem(s) 660 include a Wi-Fi modem 662, a Bluetooth modem 664, and a cellular modem 666. Output device(s) 650 includes a speaker 652 and a display 654. Input device(s) 630 includes a touch screen 632, a microphone 634, a camera 636, a physical keyboard 638, and a trackball 640. Not all components of computing device 602 shown in FIG. 6 are present in all embodiments, additional components not shown may be present, and any combination of the components may be present in a particular embodiment. These components of computing device 602 are described as follows.

A single processor 610 (e.g., central processing unit (CPU), microcontroller, a microprocessor, signal processor, ASIC (application specific integrated circuit), and/or other physical hardware processor circuit) or multiple processors 610 may be present in computing device 602 for performing such tasks as program execution, signal coding, data processing, input/output processing, power control, and/or other functions. Processor 610 may be a single-core or multi-core processor, and each processor core may be single-threaded or multithreaded (to provide multiple threads of execution concurrently). Processor 610 is configured to execute program code stored in a computer readable medium, such as program code of operating system 612 and application programs 614 stored in storage 620. The program code is structured to cause processor 610 to perform operations, including the processes/methods disclosed herein. Operating system 612 controls the allocation and usage of the components of computing device 602 and provides support for one or more application programs 614 (also referred to as “applications” or “apps”). Application programs 614 may include common computing applications (e.g., e-mail applications, calendars, contact managers, web browsers, messaging applications), further computing applications (e.g., word processing applications, mapping applications, media player applications, productivity suite applications), one or more machine learning (ML) models, as well as applications related to the embodiments disclosed elsewhere herein. Processor(s) 610 may include one or more general processors (e.g., CPUs) configured with or coupled to one or more hardware accelerators, such as one or more NPUs and/or one or more GPUs.

Any component in computing device 602 can communicate with any other component according to function, although not all connections are shown for ease of illustration. For instance, as shown in FIG. 6, bus 606 is a multiple signal line communication medium (e.g., conductive traces in silicon, metal traces along a motherboard, wires, etc.) that may be present to communicatively couple processor 610 to various other components of computing device 602, although in other embodiments, an alternative bus, further buses, and/or one or more individual signal lines may be present to communicatively couple components. Bus 606 represents one or more of any of several types of bus structures, including a memory bus or memory controller, a peripheral bus, an accelerated graphics port, and a processor or local bus using any of a variety of bus architectures.

Storage 620 is physical storage that includes one or both of memory 656 and storage device 690, which store operating system 612, application programs 614, and application data 616 according to any distribution. Non-removable memory 622 includes one or more of RAM (random access memory), ROM (read only memory), flash memory, a solid-state drive (SSD), a hard disk drive (e.g., a disk drive for reading from and writing to a hard disk), and/or other physical memory device type. Non-removable memory 622 may include main memory and may be separate from or fabricated in a same integrated circuit as processor 610. As shown in FIG. 6, non-removable memory 622 stores firmware 618, which may be present to provide low-level control of hardware. Examples of firmware 618 include BIOS (Basic Input/Output System, such as on personal computers) and boot firmware (e.g., on smart phones). Removable memory 624 may be inserted into a receptacle of or otherwise coupled to computing device 602 and can be removed by a user from computing device 602. Removable memory 624 can include any suitable removable memory device type, including an SD (Secure Digital) card, a Subscriber Identity Module (SIM) card, which is well known in GSM (Global System for Mobile Communications) communication systems, and/or other removable physical memory device type. One or more of storage device 690 may be present that are internal and/or external to a housing of computing device 602 and may or may not be removable. Examples of storage device 690 include a hard disk drive, a SSD, a thumb drive (e.g., a USB (Universal Serial Bus) flash drive), or other physical storage device.

One or more programs may be stored in storage 620. Such programs include operating system 612, one or more application programs 614, and other program modules and program data. Examples of such application programs may include, for example, computer program logic (e.g., computer program code/instructions) for implementing processor 232 utilization of hardware accelerator 202.

Storage 620 also stores data used and/or generated by operating system 612 and application programs 614 as application data 616. Examples of application data 616 include web pages, text, images, tables, sound files, video data, and other data, which may also be sent to and/or received from one or more network servers or other devices via one or more wired or wireless networks. Storage 620 can be used to store further data including a subscriber identifier, such as an International Mobile Subscriber Identity (IMSI), and an equipment identifier, such as an International Mobile Equipment Identifier (IMEI). Such identifiers can be transmitted to a network server to identify users and equipment.

A user may enter commands and information into computing device 602 through one or more input devices 630 and may receive information from computing device 602 through one or more output devices 650. Input device(s) 630 may include one or more of touch screen 632, microphone 634, camera 636, physical keyboard 638 and/or trackball 640 and output device(s) 650 may include one or more of speaker 652 and display 654. Each of input device(s) 630 and output device(s) 650 may be integral to computing device 602 (e.g., built into a housing of computing device 602) or external to computing device 602 (e.g., communicatively coupled wired or wirelessly to computing device 602 via wired interface(s) 680 and/or wireless modem(s) 660). Further input devices 630 (not shown) can include a Natural User Interface (NUI), a pointing device (computer mouse), a joystick, a video game controller, a scanner, a touch pad, a stylus pen, a voice recognition system to receive voice input, a gesture recognition system to receive gesture input, or the like. Other possible output devices (not shown) can include piezoelectric or other haptic output devices. Some devices can serve more than one input/output function. For instance, display 654 may display information, as well as operating as touch screen 632 by receiving user commands and/or other information (e.g., by touch, finger gestures, virtual keyboard, etc.) as a user interface. Any number of each type of input device(s) 630 and output device(s) 650 may be present, including multiple microphones 634, multiple cameras 636, multiple speakers 652, and/or multiple displays 654.

One or more wireless modems 660 can be coupled to antenna(s) (not shown) of computing device 602 and can support two-way communications between processor 610 and devices external to computing device 602 through network 604, as would be understood to persons skilled in the relevant art(s). Wireless modem 660 is shown generically and can include a cellular modem 666 for communicating with one or more cellular networks, such as a GSM network for data and voice communications within a single cellular network, between cellular networks, or between the mobile device and a public switched telephone network (PSTN). Wireless modem 660 may also or alternatively include other radio-based modem types, such as a Bluetooth modem 664 (also referred to as a “Bluetooth device”) and/or Wi-Fi modem 662 (also referred to as an “wireless adaptor”). Wi-Fi modem 662 is configured to communicate with an access point or other remote Wi-Fi-capable device according to one or more of the wireless network protocols based on the IEEE (Institute of Electrical and Electronics Engineers) 802.11 family of standards, commonly used for local area networking of devices and Internet access. Bluetooth modem 664 is configured to communicate with another Bluetooth-capable device according to the Bluetooth short-range wireless technology standard(s) such as IEEE 802.15.1 and/or managed by the Bluetooth Special Interest Group (SIG).

Computing device 602 can further include power supply 682, LI receiver 684, accelerometer 686, and/or one or more wired interfaces 680. Example wired interfaces 680 include a USB port, IEEE 1394 (FireWire) port, a RS-232 port, an HDMI (High-Definition Multimedia Interface) port (e.g., for connection to an external display), a DisplayPort port (e.g., for connection to an external display), an audio port, an Ethernet port, and/or an Apple® Lightning® port, the purposes and functions of each of which are well known to persons skilled in the relevant art(s). Wired interface(s) 680 of computing device 602 provide for wired connections between computing device 602 and network 604, or between computing device 602 and one or more devices/peripherals when such devices/peripherals are external to computing device 602 (e.g., a pointing device, display 654, speaker 652, camera 636, physical keyboard 638, etc.). Power supply 682 is configured to supply power to each of the components of computing device 602 and may receive power from a battery internal to computing device 602, and/or from a power cord plugged into a power port of computing device 602 (e.g., a USB port, an A/C power port). LI receiver 684 may be used for location determination of computing device 602 and may include a satellite navigation receiver such as a Global Positioning System (GPS) receiver or may include other type of location determiner configured to determine location of computing device 602 based on received information (e.g., using cell tower triangulation, etc.). Accelerometer 686 may be present to determine an orientation of computing device 602.

Note that the illustrated components of computing device 602 are not required or all-inclusive, and fewer or greater numbers of components may be present as would be recognized by one skilled in the art. For example, computing device 602 may also include one or more of a gyroscope, barometer, proximity sensor, ambient light sensor, digital compass, etc. Processor 610 and memory 656 may be co-located in a same semiconductor device package, such as being included together in an integrated circuit chip, FPGA, or system-on-chip (SOC), optionally along with further components of computing device 602.

In embodiments, computing device 602 is configured to implement any of the above-described features of flowcharts herein. Computer program logic for performing any of the operations, steps, and/or functions described herein may be stored in storage 620 and executed by processor 610.

In some embodiments, server infrastructure 670 may be present in computing environment 600 and may be communicatively coupled with computing device 602 via network 604. Server infrastructure 670, when present, may be a network-accessible server set (e.g., a cloud-based environment or platform). As shown in FIG. 6, server infrastructure 670 includes clusters 672. Each of clusters 672 may comprise a group of one or more compute nodes and/or a group of one or more storage nodes. For example, as shown in FIG. 6, cluster 672 includes nodes 674. Each of nodes 674 are accessible via network 604 (e.g., in a “cloud-based” embodiment) to build, deploy, and manage applications and services. Any of nodes 674 may be a storage node that comprises a plurality of physical storage disks, SSDs, and/or other physical storage devices that are accessible via network 604 and are configured to store data associated with the applications and services managed by nodes 674. For example, as shown in FIG. 6, nodes 674 may store application data 678.

Each of nodes 674 may, as a compute node, comprise one or more server computers, server systems, and/or computing devices. For instance, a node 674 may include one or more of the components of computing device 602 disclosed herein. Each of nodes 674 may be configured to execute one or more software applications (or “applications”) and/or services and/or manage hardware resources (e.g., processors, memory, etc.), which may be utilized by users (e.g., customers) of the network-accessible server set. For example, as shown in FIG. 6, nodes 674 may operate application programs 676. In an implementation, a node of nodes 674 may operate or comprise one or more virtual machines, with each virtual machine emulating a system architecture (e.g., an operating system), in an isolated manner, upon which applications such as application programs 676 may be executed.

In an embodiment, one or more of clusters 672 may be co-located (e.g., housed in one or more nearby buildings with associated components such as backup power supplies, redundant data communications, environmental controls, etc.) to form a datacenter, or may be arranged in other manners. Accordingly, in an embodiment, one or more of clusters 672 may be a datacenter in a distributed collection of datacenters. In embodiments, exemplary computing environment 600 comprises part of a cloud-based platform such as Amazon Web Services® of Amazon Web Services, Inc., or Google Cloud Platform™ of Google LLC, although these are only examples and are not intended to be limiting.

In an embodiment, computing device 602 may access application programs 676 for execution in any manner, such as by a client application and/or a browser at computing device 602. Example browsers include Microsoft Edge® by Microsoft Corp. of Redmond, Washington, Mozilla Firefox®, by Mozilla Corp. of Mountain View, California, Safari®, by Apple Inc. of Cupertino, California, and Google® Chrome by Google LLC of Mountain View, California.

For purposes of network (e.g., cloud) backup and data security, computing device 602 may additionally and/or alternatively synchronize copies of application programs 614 and/or application data 616 to be stored at network-based server infrastructure 670 as application programs 676 and/or application data 678. For instance, operating system 612 and/or application programs 614 may include a file hosting service client, such as Microsoft® OneDrive® by Microsoft Corporation, Amazon Simple Storage Service (Amazon S3)® by Amazon Web Services, Inc., Dropbox® by Dropbox, Inc., Google Drive™ by Google LLC, etc., configured to synchronize applications and/or data stored in storage 620 at network-based server infrastructure 670.

In some embodiments, on-premises servers 692 may be present in computing environment 600 and may be communicatively coupled with computing device 602 via network 604. On-premises servers 692, when present, are hosted within an organization's infrastructure and, in many cases, physically onsite of a facility of that organization. On-premises servers 692 are controlled, administered, and maintained by IT (Information Technology) personnel of the organization or an IT partner to the organization. Application data 698 may be shared by on-premises servers 692 between computing devices of the organization, including computing device 602 (when part of an organization) through a local network of the organization, and/or through further networks accessible to the organization (including the Internet). Furthermore, on-premises servers 692 may serve applications such as application programs 696 to the computing devices of the organization, including computing device 602. Accordingly, on-premises servers 692 may include storage 694 (which includes one or more physical storage devices such as storage disks and/or SSDs) for storage of application programs 696 and application data 698 and may include one or more processors for execution of application programs 696. Still further, computing device 602 may be configured to synchronize copies of application programs 614 and/or application data 616 for backup storage at on-premises servers 692 as application programs 696 and/or application data 698.

Embodiments described herein may be implemented in one or more of computing device 602, network-based server infrastructure 670, and on-premises servers 692. For example, in some embodiments, computing device 602 may be used to implement systems, clients, or devices, or components/subcomponents thereof, disclosed elsewhere herein. In other embodiments, a combination of computing device 602, network-based server infrastructure 670, and/or on-premises servers 692 may be used to implement the systems, clients, or devices, or components/subcomponents thereof, disclosed elsewhere herein.

As used herein, the terms “computer program medium,” “computer-readable medium,” and “computer-readable storage medium,” etc., are used to refer to physical hardware media. Examples of such physical hardware media include any hard disk, optical disk, SSD, other physical hardware media such as RAMs, ROMs, flash memory, digital video disks, zip disks, MEMs (microelectronic machine) memory, nanotechnology-based storage devices, and further types of physical/tangible hardware storage media of storage 620. Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared, and other wireless media, as well as wired media. Embodiments are also directed to such communication media that are separate and non-overlapping with embodiments directed to computer-readable storage media.

As noted above, computer programs and modules (including application programs 614) may be stored in storage 620. Such computer programs may also be received via wired interface(s) 680 and/or wireless modem(s) 660 over network 604. Such computer programs, when executed or loaded by an application, enable computing device 602 to implement features of embodiments discussed herein. Accordingly, such computer programs represent controllers of the computing device 602.

Embodiments are also directed to computer program products comprising computer code or instructions stored on any computer-readable medium or computer-readable storage medium. Such computer program products include the physical storage of storage 620 as well as further physical storage types.

### V. Additional Example Embodiments

Systems, methods, and instrumentalities are described herein related to artificial intelligence (AI) optimization for combining pre-processing with quantization and post-processing with dequantization. Algorithms with float inputs may be implemented as fixed point to fixed point (e.g., unsigned integer (uint) to integer (int)) algorithms. A float algorithm and associated floating point precision may be mimicked, for example, using high precision parameters in a fixed point to fixed point algorithm. Mimicking floating point using hardware acceleration may reduce sequential operations, such as machine learning (ML) model preprocessing and quantization by a central processing unit (CPU), to one or two clock cycles in a single step operation. Accordingly, computing resources, such as computing device cameras, may provide raw data (e.g., uint RGB image data) to a hardware accelerator (e.g., neural processing unknit (NPU)) configured to quickly render the input in the correct format to an inference model by simultaneously performing preprocessing and quantization, substantially reducing inference latency and device power consumption while freeing up a CPU for other tasks.

For example, a computing system may include a hardware accelerator (e.g., NPU) configured to receive data in a first fixed point format different from a second fixed point format that a ML model is configured to process; convert the data from the first fixed point format to the second fixed point format in a first operation with a first set of parameters, wherein the first operation approximates, but avoids, sequential operations comprising an intermediate conversion of the received data to a floating point format and conversion of the floating point format to the second fixed point format, which enables the data in the second fixed point format to approximate floating point precision; and implement the ML model to process the data in the second fixed point format.

In examples, the hardware accelerator is further configured to: detect at least one of a type of the data or a format of the data; generate, based at least on the detection, an operation descriptor indicating the first operation and the first set of parameters; and provide the operation descriptor to configure the conversion.

In examples, the first operation may comprise modified dequantization and the approximated sequential operations may comprise quantization and postprocessing of data for the ML model.

In examples, the first operation may comprise modified quantization and the approximated sequential operations may comprise preprocessing of data for the ML model and quantization.

In examples, the first set of parameters for the modified quantization may comprise at least one parameter for the quantization (e.g., learned quantization scale divisor and constant K) and at least one parameter for the preprocessing (e.g., 255 divisor for uint8).

In examples, the first operation may comprise multiplication and addition.

In examples, the first fixed point format may comprise unsigned integer format and the second fixed point format may comprise integer format.

In some examples, at least one parameter in the first set of parameters may be a high precision parameter (e.g., 32-bit multiplier) that approximates floating point precision.

In examples, the data may comprise raw image data (e.g., received from a camera resource for direct integration with NPU image analyses).

In examples, a computer-readable storage medium may have instructions recorded thereon that, when executed by a hardware accelerator, implement a method. The method may comprise receiving data in a first fixed point format; and converting the received data from the first fixed point format to a second fixed point format in a first operation with a first set of parameters, wherein the first operation approximates sequential operations comprising an intermediate conversion of the first fixed point format to a floating point format and conversion of the floating point format to the second fixed point format, which enables the data in the second fixed point format to approximate floating point precision.

In examples, a method may comprise receiving data in a first fixed point format; converting the received data from the first fixed point format to a second fixed point format in a first operation with a first set of parameters, wherein the first operation approximates sequential operations comprising an intermediate conversion of the first fixed point format to a floating point format and conversion of the floating point format to the second fixed point format; and processing the data in the second fixed point format to approximate floating point precision.

In examples, the first operation may be implemented by a hardware accelerator (e.g., NPU, GPU).

In examples, the method may further comprise detecting at least one of a type of the data (e.g., image data) or a format of the data (e.g., floating point, fixed point, such as uint8); generating, based on at least the detection (e.g., also expected model input format and/or expected output format), an operation descriptor indicating the first operation and the first set of parameters; and providing the operation descriptor to configure said converting.

In examples, the first operation may comprise modified dequantization and the approximated sequential operations may comprise quantization and postprocessing of data for a machine learning (ML) model.

In examples, the first operation may comprise modified quantization and the approximated sequential operations may comprise preprocessing of data for a machine learning (ML) model and quantization.

In examples, the first set of parameters for the modified quantization may comprise at least one parameter for the quantization (e.g., learned quantization scale divisor and constant K) and at least one parameter for the preprocessing (e.g., 255 divisor for uint8).

In examples, the first operation may comprise multiplication and addition.

In examples, the first fixed point format may comprise unsigned integer format and the second fixed point format may comprise integer format.

In examples, at least one parameter in the first set of parameters may be a high precision parameter that approximates floating point precision.

In examples, the data may comprise raw image data (e.g., received from a camera resource for direct integration with NPU image analyses).

### VI. Conclusion

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the discussion, unless otherwise stated, adjectives modifying a condition or relationship characteristic of a feature or features of an implementation of the disclosure, should be understood to mean that the condition or characteristic is defined to within tolerances that are acceptable for operation of the implementation for an application for which it is intended. Furthermore, if the performance of an operation is described herein as being “in response to” one or more factors, it is to be understood that the one or more factors may be regarded as a sole contributing factor for causing the operation to occur or a contributing factor along with one or more additional factors for causing the operation to occur, and that the operation may occur at any time upon or after establishment of the one or more factors. Still further, where “based on” is used to indicate an effect being a result of an indicated cause, it is to be understood that the effect is not required to only result from the indicated cause, but that any number of possible additional causes may also contribute to the effect. Thus, as used herein, the term “based on” should be understood to be equivalent to the term “based at least on.”

Numerous example embodiments have been described above. Any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

Furthermore, example embodiments have been described above with respect to one or more running examples. Such running examples describe one or more particular implementations of the example embodiments; however, embodiments described herein are not limited to these particular implementations.

Moreover, according to the described embodiments and techniques, any components of systems, computing devices, servers, device management services, virtual machine provisioners, applications, and/or data stores and their functions may be caused to be activated for operation/performance thereof based on other operations, functions, actions, and/or the like, including initialization, completion, and/or performance of the operations, functions, actions, and/or the like.

In some example embodiments, one or more of the operations of the flowcharts described herein may not be performed. Moreover, operations in addition to or in lieu of the operations of the flowcharts described herein may be performed. Further, in some example embodiments, one or more of the operations of the flowcharts described herein may be performed out of order, in an alternate sequence, or partially (e.g., or completely) concurrently with each other or with other operations.

The embodiments described herein and/or any further systems, sub-systems, devices and/or components disclosed herein may be implemented in hardware (e.g., hardware logic/electrical circuitry), or any combination of hardware with software (e.g., computer program code configured to be executed in one or more processors or processing devices) and/or firmware.

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A computing system, comprising:
a hardware accelerator configured to:
receive data in a first fixed point format different from a second fixed point format that a machine learning (ML) model is configured to process;
convert the data from the first fixed point format to the second fixed point format in a first operation with a first set of parameters, wherein the first operation approximates sequential operations comprising an intermediate conversion of the received data to a floating point format and conversion of the floating point format to the second fixed point format, which enables the data in the second fixed point format to approximate floating point precision; and
implement the ML model to process the data in the second fixed point format.

2. The computing system of claim 1, wherein the hardware accelerator is further configured to:
detect at least one of a type of the data or a format of the data;
generate, based at least on the detection, an operation descriptor indicating the first operation and the first set of parameters; and
provide the operation descriptor to configure the conversion.

3. The computing system of claim 1, wherein the first operation comprises modified dequantization and the approximated sequential operations comprise quantization and postprocessing of data for the ML model.

4. The computing system of claim 1, wherein the first operation comprises modified quantization and the approximated sequential operations comprise preprocessing of data for the ML model and quantization.

5. The computing system of claim 4, wherein the first set of parameters for the modified quantization comprises at least one parameter for the quantization and at least one parameter for the preprocessing.

6. The computing system of claim 1, wherein the first operation comprises multiplication and addition.

7. The computing system of claim 1, wherein the first fixed point format comprises unsigned integer format and the second fixed point format comprises integer format.

8. The computing system of claim 1, wherein at least one parameter in the first set of parameters is a high precision parameter that approximates floating point precision.

9. The computing system of claim 1, wherein the data comprises raw image data.

10. A computer-readable storage medium having instructions recorded thereon that, when executed by a hardware accelerator, implements a method comprising:
receiving data in a first fixed point format; and
converting the received data from the first fixed point format to a second fixed point format in a first operation with a first set of parameters, wherein the first operation approximates sequential operations comprising an intermediate conversion of the first fixed point format to a floating point format and conversion of the floating point format to the second fixed point format, which enables the data in the second fixed point format to approximate floating point precision.

11. A method, comprising:
receiving data in a first fixed point format;
converting the received data from the first fixed point format to a second fixed point format in a first operation with a first set of parameters, wherein the first operation approximates sequential operations comprising an intermediate conversion of the first fixed point format to a floating point format and conversion of the floating point format to the second fixed point format; and
processing the data in the second fixed point format to approximate floating point precision.

12. The method of claim 11, wherein the first operation is implemented by a hardware accelerator.

13. The method of claim 11, further comprising:
detecting at least one of a type of the data or a format of the data;
generating, based on at least the detection, an operation descriptor indicating the first operation and the first set of parameters; and
providing the operation descriptor to configure said converting.

14. The method of claim 11, wherein the first operation comprises modified dequantization and the approximated sequential operations comprise quantization and postprocessing of data for a machine learning (ML) model.

15. The method of claim 11, wherein the first operation comprises modified quantization and the approximated sequential operations comprise preprocessing of data for a machine learning (ML) model and quantization.

16. The method of claim 15, wherein the first set of parameters for the modified quantization comprises at least one parameter for the quantization and at least one parameter for the preprocessing.

17. The method of claim 11, wherein the first operation comprises multiplication and addition.

18. The method of claim 11, wherein the first fixed point format comprises unsigned integer format and the second fixed point format comprises integer format.

19. The method of claim 11, wherein at least one parameter in the first set of parameters is a high precision parameter that approximates floating point precision.

20. The method of claim 11, wherein the data comprises raw image data.
